(19) United States
(12) Patent Application Publication
(10) Pub. No.: US 2025/0198801 A1
(43) Pub. Date: Jun. 19, 2025

(54) Calibration of Sensors in Devices

(71) Applicant: Cisco Technology, Inc., San Jose, CA (US)

(72) Inventors: Antonio Trifilo, Pully (CH); Roberto Muccifora, Ropraz (CH); Amine Choukir, Ecublens (CH); Audrey Yazdanparast, Akron, OH (US); Philip Davis, Richardson, TX (US); Peiman Amini, Fremont, CA (US); Evgeny Yankevich, Beachwood, OH (US); Matthew Silverman, Shaker Heights, OH (US); Sachin D. Wakudkar, St-Sulpice (CH); Pascal Thubert, Roquefort-les-Pins (FR); Domenico Ficara, Essertines-sur-Yverdon (CH); Brian Hart, Sunnyvale, CA (US)

(21) Appl. No.: 18/539,071

(22) Filed: Dec. 13, 2023

(51) Int. Cl. G01C 25/00; G01C 5/06

(52) U.S. Cl. CPC G01C 25/00; G01C 5/06

(57) ABSTRACT

Devices, networks, systems, methods, and processes for calibration of barometric sensors in the devices are described herein. A device may include a barometric sensor for measuring an observed pressure value at a geolocation of the device. The device can receive one or more reference pressure values from multiple sources. The device may compare the one or more reference pressure values with the observed pressure value to determine an offset pressure value. The device can calibrate or re-calibrate the barometric sensor based on the offset pressure value. The device may determine an altitude value based on the observed pressure value. The device can further optimize the altitude value after calibration of the barometric sensor. The device may dynamically re-calibrate the barometric sensor to adapt to changing environmental conditions in real-time. The device may also periodically re-calibrate the barometric sensor to reduce or eliminate an effect of drift in the barometric sensor.

The present disclosure relates to communication networks. More particularly, the present disclosure relates to calibrating pressure sensors in devices in a communication network.

### BACKGROUND

Modern communication networks frequently utilize Wi-Fi for communicating wirelessly between multiple devices in a communication network. As the utilization of Wi-Fi grows rapidly, there is an increasing demand for improved connectivity and higher speeds. Solutions such as Wi-Fi 6E/Wi-Fi 7 can provide better connectivity and better speeds by operating in unlicensed 6 GHz spectrum that can support wider channels. However, traditionally, 6 GHz spectrum is utilized by existing communication systems, also known as incumbent networks. Therefore, it is essential that the communication network utilizing Wi-Fi 6/Wi-Fi 7 in 6 GHz spectrum does not interfere with the incumbent networks.

A unique challenge arises when the communication network operates at higher altitudes, for instance in tall buildings or skyscrapers. At the higher altitudes, network devices in the communication network, such as Access Points (APs), can cover a larger area, thereby increasing chances of interfering with the incumbent networks nearby. Further, compliance with Federal Communications Commission (FCC) regulations adds more complexity, thereby necessitating the communication network to have an automated solution for altitude measurement. Typically, the APs in the communication network report an altitude and a geolocation to Automatic Frequency Coordinators (AFCs). The AFCs can utilize the altitude and the geolocation to access a database of the incumbent networks to determine if the APs in the communication network can operate on 6 GHz spectrum without interfering with any incumbent network nearby.

For altitude measurement, the APs can be provided with pressure sensors to measure atmospheric pressure. A pressure measurement from a pressure sensor in an AP can be utilized to determine the altitude at which the AP is deployed. However, the pressure sensors drift over time. The drift may be caused by aging of the pressure sensors, seasonal pressure variations, temperature and humidity extremes, material responses and other environmental variations. Further, determination of the altitude based on the pressure measurement may differ in different weather conditions. This necessitates calibration of the pressure sensors to maintain accuracy. Consequently, finding a solution that can utilize accurate reference pressure data that factors in environmental variations and weather conditions is crucial. Therefore, there is a need for a system that can accurately calibrate the pressure sensors in the APs in the communication network.

### SUMMARY OF THE DISCLOSURE

Systems and methods for calibrating pressure sensors in devices in a communication network in accordance with embodiments of the disclosure are described herein. In some embodiments, a device includes a processor, a memory communicatively coupled to the processor, and a dynamic calibration logic. The logic is configured to detect a geolocation of the device, measure an observed pressure value corresponding to the geolocation, receive one or more reference pressure values associated with the geolocation, and determine an offset pressure value based on the observed pressure value and the one or more reference pressure values.

In some embodiments, the dynamic calibration logic is further configured to receive weather data, retrieve a plurality of historical pressure values associated with the weather data from a weather database, determine an average of the plurality of historical pressure values, determine a difference between the observed pressure value and the average of the plurality of historical pressure values, and determine the offset pressure value based on the difference.

In some embodiments, the dynamic calibration logic is further configured to receive weather data, retrieve a plurality of historical pressure values associated with the weather data from a weather database, and determine the offset pressure value based on the plurality of historical pressure values.

In some embodiments, the dynamic calibration logic is further configured to determine a plurality of difference values, wherein each difference value of the plurality of difference values corresponds to a difference between the observed pressure value and a historical pressure value of the plurality of historical pressure values, determine an average of the plurality of difference values, and determine the offset pressure value based on the average of the plurality of difference values.

In some embodiments, a device further includes a Global Navigation Satellite System (GNSS) receiver configured to detect the geolocation.

In some embodiments, a device further includes a barometric sensor configured to measure the observed pressure value.

In some embodiments, the dynamic calibration logic is further configured to calibrate the barometric sensor based on the offset pressure value.

In some embodiments, the barometric sensor is further configured to measure an optimized pressure value after calibration.

In some embodiments, the dynamic calibration logic is further configured to discover a plurality of network devices.

In some embodiments, the dynamic calibration logic is further configured to determine a first network device of the plurality of network devices having lowest barometric sensor uptime, and receive a first reference pressure value of the one or more reference pressure values from the first network device.

In some embodiments, the dynamic calibration logic is further configured to transmit a query to a barometric pressure server, and receive a second reference pressure value of the one or more reference pressure values from the barometric pressure server in response to the query.

In some embodiments, the dynamic calibration logic is further configured to determine an optimized altitude based on one or more reference altitude values.

In some embodiments, the dynamic calibration logic is further configured to calibrate the barometric sensor based on the optimized altitude.

In some embodiments, the dynamic calibration logic is further configured to transmit the optimized altitude to one or more network devices of the plurality of network devices.

In some embodiments, the dynamic calibration logic is further configured to receive a first reference altitude value of the one or more reference altitude values or a third reference pressure value of the one or more reference pressure values from an external device.

In some embodiments, the dynamic calibration logic is further configured to receive a plurality of wireless signals from the plurality of network devices, receive a plurality of altitude values from the plurality of network devices, determine a plurality of Received Signal Strength Indicator (RSSI) values for the plurality of wireless signals, determine a weighted average based on the plurality of altitude values and corresponding plurality of RSSI values, and determine a second reference altitude value of the one or more reference altitude values based on the weighted average.

In some embodiments, a device includes a processor, a memory communicatively coupled to the processor, a Global Navigation Satellite System (GNSS) receiver configured to detect a geolocation of the device, a barometric sensor configured to measure an observed pressure value corresponding to the geolocation, and a dynamic calibration logic. The logic is configured to receive one or more reference pressure values associated with the geolocation, determine an offset pressure value based on the observed pressure value and the one or more reference pressure values, and calibrate the barometric sensor based on the offset pressure value.

In some embodiments, the dynamic calibration logic is further configured to determine an optimized altitude based on one or more reference altitude values.

In some embodiments, the dynamic calibration logic is further configured to calibrate the barometric sensor based on the optimized altitude.

In some embodiments, the dynamic calibration logic is further configured to transmit the optimized altitude to one or more network devices.

In some embodiments, a method includes detecting a geolocation by utilizing a Global Navigation Satellite System (GNSS) receiver, measuring an observed pressure value corresponding to the geolocation by utilizing a barometric sensor, receiving one or more reference pressure values associated with the geolocation, determining an offset pressure value based on the observed pressure value and the one or more reference pressure values, and calibrating the barometric sensor based on the offset pressure value.

In some embodiments, a method further includes determining an optimized altitude based on one or more reference altitude values, and calibrating the barometric sensor based on the optimized altitude.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a network, in accordance with various embodiments of the disclosure;

FIG. 2 is a conceptual illustration of a network, in accordance with various embodiments of the disclosure;

FIG. 3 is a conceptual network diagram of various environments that a pressure sensor calibrator may operate on a plurality of network devices, in accordance with various embodiments of the disclosure;

FIG. 4 is a flowchart depicting a process for calibrating a barometric sensor, in accordance with various embodiments of the disclosure;

FIG. 5 is a flowchart depicting a process for determining an offset pressure value, in accordance with various embodiments of the disclosure;

FIG. 6 is a flowchart depicting a process for determining an offset pressure value, in accordance with various embodiments of the disclosure;

FIG. 7 is a flowchart depicting a process for determining a reference altitude value, in accordance with various embodiments of the disclosure; and

FIG. 8 is a conceptual block diagram of a device suitable for configuration with a dynamic calibration logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that calibrate barometric sensors in devices. In many embodiments, one or more network devices, such as Access Points (APs), in a network may comprise barometric sensors. The barometric sensors can measure atmospheric pressures at locations where the APs are deployed. The network may have multiple interconnected APs deployed at various distances. Each AP can discover other APs in the network by utilizing one or more communication protocols. The APs may also discover other APs at boot-up or when a new AP is added to the network. In some embodiments, for example, each AP may comprise a barometric sensor. In certain embodiments, for example, a few APs may comprise barometric sensors and may share measurements received from the barometric sensors with the other APs. In more embodiments, one or more barometric sensors can be utilized commonly by one or more interconnected APs. Additionally, one or more APs in the network may comprise Global Navigation Satellite System (GNSS) receivers. The GNSS receivers can determine geolocations of the APs. In numerous embodiments, each AP may comprise a GNSS receiver. In many further embodiments, a few APs may comprise GNSS receivers and may share the geolocation information received from the GNSS receivers with the other APs. In some more embodiments, the GNSS receivers can be included in one or more devices in proximity of the APs, i.e., the GNSS receivers may not be co-located within the APs. In this case, the APs may utilize one or more closest GNSS receivers to determine the geolocations of the APs. The geolocations determined by the GNSS receivers in the devices may be close enough to have same or substantially similar pressure as the APs.

In a number of embodiments, the GNSS receiver in the AP or a GNSS receiver in a device in proximity of the AP can determine a geolocation of the AP. The barometric sensor in the AP can measure an observed pressure value corresponding to the geolocation of the AP. The AP may further receive one or more reference pressure values associated with the geolocation. The AP can utilize the reference pressure values to calibrate or re-calibrate the barometric sensor. In that, the AP may determine an offset pressure value based on the observed pressure value and the one or more reference pressure values. The AP can calibrate or re-calibrate the barometric sensor based on the offset pressure value. After calibration or re-calibration, the barometric sensor may measure an optimized pressure value. The AP may transmit the optimized pressure value to the other APs in the network.

In various embodiments, the AP may receive weather data from a weather server. The weather server can provide the weather data indicative of real-time environmental conditions or weather conditions at the geolocation. The AP can further access a weather database. The weather database may store historical data associated with weather conditions or environmental conditions. The historical weather data can include historical pressure values associated with various weather conditions and environmental conditions for various geolocations. In more embodiments, the AP may access the weather database by way of wired or wireless communication networks such as internet. In some more embodiments, the AP may access an online server capable of providing historical data associated with weather conditions or environmental conditions. In numerous embodiments, the weather database may be within the network or external to the network. The AP can receive historical pressure values associated with the weather data from the weather database. In many further embodiments, the historical pressure values can be associated with an environmental or weather condition similar to the real-time environmental or weather condition indicated by the weather data. In still more embodiments, the historical pressure values may be associated with different environmental or weather conditions, or may be an average of pressure values in similar environmental or weather conditions. In many additional embodiments, the AP can determine an average of the historical pressure values. The AP may thereafter determine a pressure difference between the observed pressure value and the average of the historical pressure values. The AP can determine the offset pressure value based on the pressure difference. The AP may utilize the offset pressure to calibrate or re-calibrate the barometric sensor. The AP can also determine a plurality of difference values. Each difference value may be a difference between the observed pressure value and the historical pressure values. The historical pressure values and the observed pressure value may be measured at same time or at a substantially similar time. The AP may determine an average of the difference values. The AP can further determine the offset value based on the average of the difference values.

In additional embodiments, the AP may, after discovering the other APs in the network, determine uptimes of the other APs or the uptimes of the barometric sensors in the other APs. In some embodiments, for example, the new AP that is newly added to the network may have the lowest uptime. As the APs are typically calibrated while adding to the network, the new AP may have most accurate measurements for pressure or altitude. The AP may receive the reference pressure value from the new AP. In certain embodiments, the AP can receive a reference altitude value from the new AP. The AP may utilize the reference pressure value or the reference altitude value, received from the new AP, to calibrate or re-calibrate the barometric sensor.

In further embodiments, the AP can transmit a query to a barometric pressure server. In some embodiments, for example, the barometric pressure server may store historical pressure values for various environmental conditions or weather conditions. The AP may receive the reference pressure value from the barometric pressure server. The AP can further utilize the reference pressure value received from the barometric pressure server to calibrate or re-calibrate the barometric sensor.

In many more embodiments, the AP may be in communication with one or more external devices. In some embodiments, the external devices can be handheld devices such as smartphones or smart watches, or computing devices such as desktops, laptops, or servers, for example. In certain embodiments, the external devices may be active or passive Wi-Fi tags, home automation devices, or thermostats, for example. In more embodiments, the external devices can be one or more visual references correlated with one or more databases, for example. The AP can receive the reference pressure value or the reference altitude value from the one or more external devices. In some more embodiments, the AP can receive the reference pressure value or the reference altitude value from a smartphone by utilizing Bluetooth, for example. The AP may utilize the reference pressure value or the reference altitude value, received from the one or more external devices, to calibrate or re-calibrate the barometric sensor.

In many additional embodiments, the AP can receive wireless signals or Wi-Fi signals from the other APs in the network. The AP can also receive one or more altitude values from the other APs. The AP may determine strengths of the wireless signals received from the other APs. In some embodiments, for example, the AP can determine Received Signal Strength Indicator (RSSI) values for the wireless signals. In certain embodiments, for example, the wireless signals from the other APs that are at larger distances may have poor RSSI values (for e.g., −80 dBm) than the APs that are at smaller distances (for e.g., −60 dBm). The AP may determine a weighted average based on the RSSI values and corresponding altitudes to obtain the reference altitude value. In some embodiments, for example, the altitude value obtained from the AP with poor RSSI can be given a lower weightage and the altitude value obtained from the AP with better RSSI can be given a higher weightage. The AP may utilize the reference altitude value obtained by the weighted average to calibrate or re-calibrate the barometric sensor.

Advantageously, the network may utilize the barometric sensors in the APs to determine the altitudes of the APs. The APs can calibrate the barometric sensors by utilizing various methods, various reference pressure values, and reference altitude values, for example. The APs may dynamically calibrate or re-calibrate the barometric sensors to adapt to changing weather conditions or environmental variations. The APs can also periodically re-calibrate the barometric sensors to avoid or reduce the drift in the pressure measurements. The optimized pressure value measured by the barometric sensor after calibration may be more accurate than the observed pressure value that was measured by the barometric sensor initially, thereby improving an accuracy of pressure measurement. Since the pressure measurement may be further utilized to determine or estimate the altitude of the AP, increase in the accuracy of the pressure measurement consequently increases an accuracy of the determined altitude. Further, the network may utilize the altitude to adjust frequency or power of the wireless signals in the network, thereby improving efficiency of the network. Effectively, self-calibration of the barometric sensors in the APs can improve network efficiency and accuracy.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

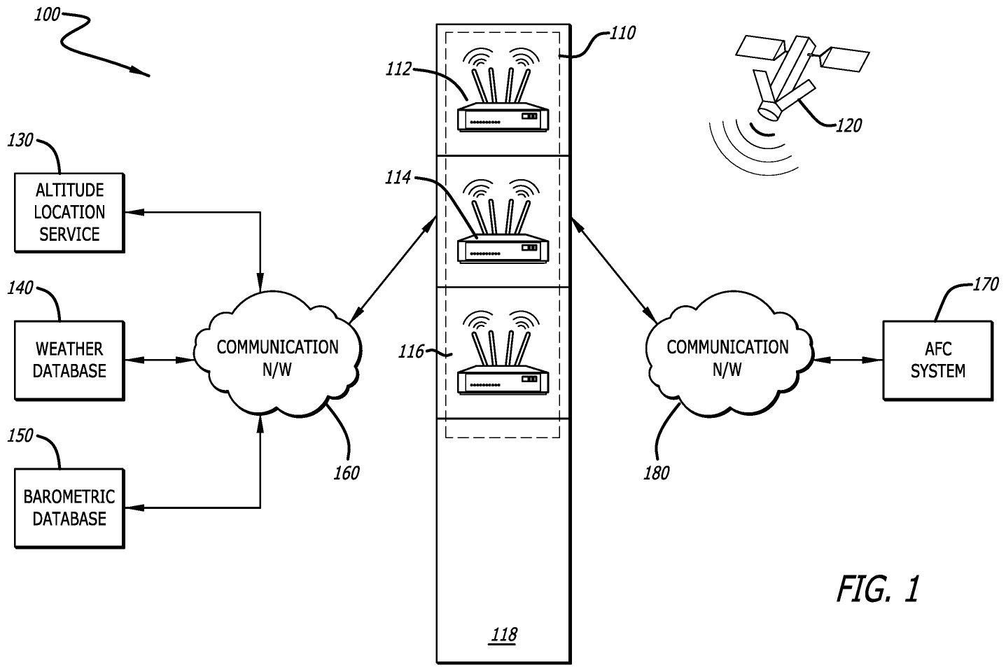

Referring to FIG. 1, a conceptual illustration of a network 100, in accordance with various embodiments of the disclosure is shown. In many embodiments, the network 100 may comprise a plurality of Access Points (APs) 110 including a first AP 112, a second AP 114, and a third AP 116, located in an establishment 118. The APs 110 may be in communication with a satellite 120. The APs can be in communication with an altitude location service 130, a weather database 140, and a barometric database 150 by way of a first communication network 160. The APs 110 may be in communication with an Automatic Frequency Coordination (AFC) system 170 by way of a second communication network 180.

In a number of embodiments, the network 100 may operate on Wi-Fi. In some embodiments, the network 100 can operate on 2.4 GHz or 5 GHz spectrum. In certain embodiments, the network 100 may operate on Wi-Fi 6E/Wi-Fi 7 in 6 GHz spectrum. The establishment 118 may be a building. The first communication network 160 and the second communication network 180 can be wired and/or wireless communication networks, including internet. In more embodiments, the first communication network 160 and the second communication network 180 may be a single communication network or two distinct communication networks. In some more embodiments, the APs 110 can include Global Navigation Satellite System (GNSS) receivers to communicate with the satellite 120. The GNSS receivers can also determine geolocation of the APs 110. In many embodiments, the GNSS receivers can be included in one or more devices in proximity of the APs 110, i.e., the GNSS receivers may not be co-located within the APs 110. In this case, the APs 110 may utilize one or more closest GNSS receivers to determine the geolocations of the APs 110. The APs 110 can include barometric sensors to measure pressure values. The APs 110 may provide the pressure values to the altitude location service 130. In numerous embodiments, the altitude location service 130 can be a server or a Software as a Service (SaaS) that can provide altitude information based on the pressure values received from the APs 110. In many further embodiments, the altitude location service 130 may verify accuracy of pressure values received from the APs 110. The APs 110 may query the barometric database 150 to receive reference pressure values. The weather database 140 may store historical data associated with weather conditions or environmental conditions. The APs 110 can receive the reference pressure values from the weather database 140. The APs 110 can calibrate or re-calibrate the barometric sensors based on the reference pressure values. The APs 110 may determine optimized pressure values after optimization of the barometric sensors. The APs 110 can thereafter determine the altitude based on the optimized pressure values. The APs 110 may transmit the altitude and the geolocation to the AFC system 170 to determine whether the APs 110 can operate on 6 GHz spectrum.

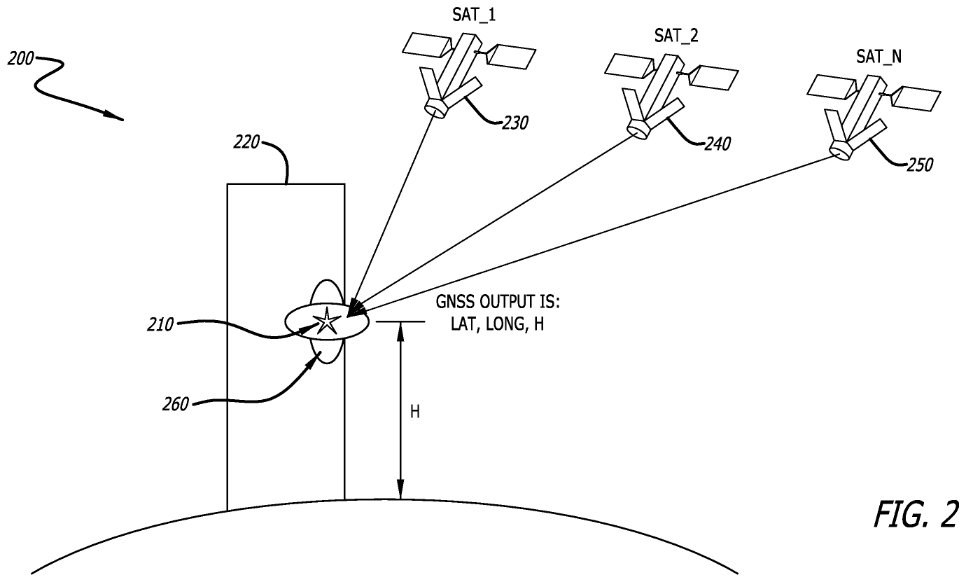

Although a specific embodiment for the network 100 for carrying out the various steps, processes, methods, and operations described herein is discussed with respect to FIG. 1, any of a variety of systems and/or processes may be utilized in accordance with embodiments of the disclosure. For example, the network 100 may self-calibrate the barometric sensors in the APs 110. The elements depicted in FIG. 1 may also be interchangeable with other elements of FIGS. 2-8 as required to realize a particularly desired embodiment.

Referring to FIG. 2, a conceptual illustration of a network 200, in accordance with various embodiments of the disclosure is shown. The network 200 may comprise an AP 210 located in a building 220. The AP 210 can be in communication with first through third satellites 230, 240, and 250. The AP 210 may include a GNSS receiver to determine the geolocation of the AP 210 and to communicate with the first through third satellites 230, 240, and 250. The GNSS receiver can also determine GNSS or Global Positioning System (GPS) measurements for the AP 210. In many embodiments, the GNSS receiver can be included in a device that is in proximity of the AP 210, i.e., the GNSS receiver may not be co-located within the AP 210. In this case, the geolocation determined by the GNSS receiver in the device may be close enough to have same or substantially similar pressure as the AP 210. In some embodiments, for example, the GNSS or GPS measurements, or the geolocation, should lie within a sphere or a geoid 260 of a predetermined diameter around the AP 210. In certain embodiments, for example, the predetermined diameter can be 1 m for GPS measurements, for example. In more embodiments, the predetermined diameter can be 2 cm in Real-Time Kinematic (RTK) fixed mode positioning, for example. In some more embodiments, for example, the AP 210 may average the GNSS or GPS measurements to determine latitude, longitude, or height corresponding to the geoid 260 at the geolocation.

In a number of embodiments, the AP 210 can access a weather server to receive expected atmospheric pressure for different time moments with different weather conditions. The different weather conditions may include seasonal variations throughout a year. The AP 210 may also measure the atmospheric pressure by utilizing a barometric sensor. The AP 210 can compare the expected atmosphere pressure for the geolocation and the height of the geoid 260 with the measured atmospheric pressure. The AP 210 may periodically calibrate the barometric sensor based on results of the comparison.

Although a specific embodiment for the network 200 for carrying out the various steps, processes, methods, and operations described herein is discussed with respect to FIG. 2, any of a variety of systems and/or processes may be utilized in accordance with embodiments of the disclosure. For example, the network 200 may utilize real-time weather data received from the weather server to calibrate the barometric sensor in the AP 210. The elements depicted in FIG. 2 may also be interchangeable with other elements of FIG. 1 and FIGS. 3-8 as required to realize a particularly desired embodiment.

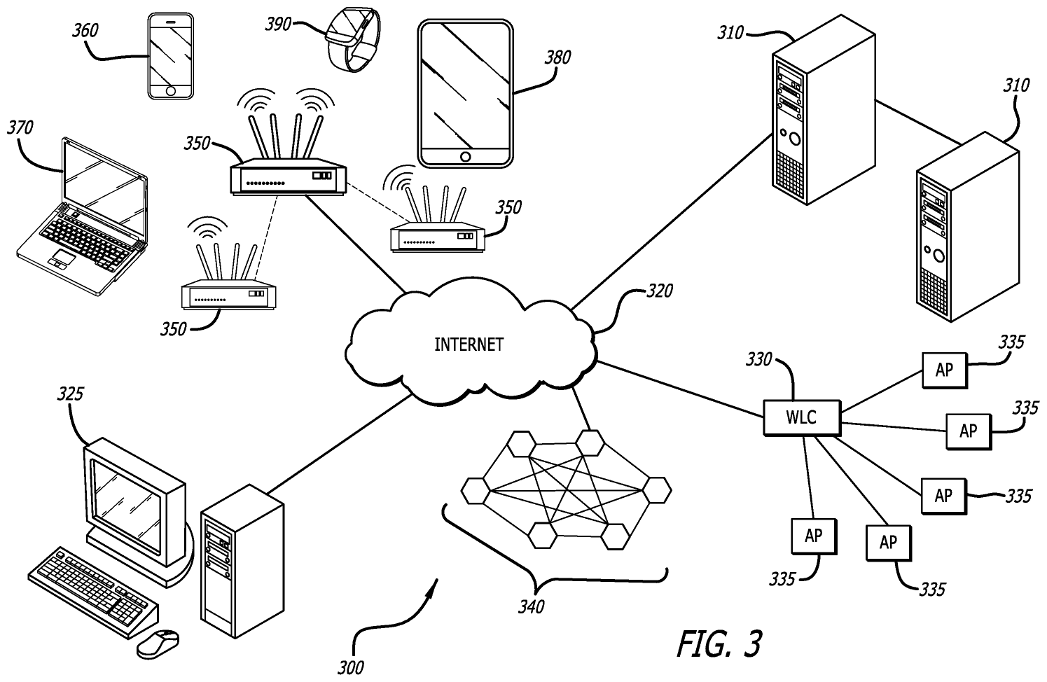

Referring to FIG. 3, a conceptual network diagram 300 of various environments that a pressure sensor calibrator may operate on a plurality of network devices, in accordance with various embodiments of the disclosure is shown. Those skilled in the art will recognize that the pressure sensor calibrator can be comprised of various hardware and/or software deployments and can be configured in a variety of ways. In many embodiments, the pressure sensor calibrator can be configured as a standalone device, exist as a logic in another network device, be distributed among various network devices operating in tandem, or remotely operated as part of a cloud-based network management tool. In further embodiments, one or more servers 310 can be configured with or otherwise operate the pressure sensor calibrator. In many embodiments, the pressure sensor calibrator may operate on one or more servers 310 connected to a communication network 320. The communication network 320 can include wired networks or wireless networks. In many embodiments, the communication network 320 may be a Wi-Fi network operating on various frequency bands, such as, 2.4 GHZ, 5 GHZ, or 6 GHz. In further embodiments, the pressure sensor calibrator operating on the servers 310 can calibrate pressure sensors on various devices. The pressure sensor calibrator can be provided as a cloud-based service that can service remote networks, such as, but not limited to a deployed network 340. In many embodiments, the pressure sensor calibrator can be a logic that calibrates the pressure sensors in the APs.

However, in additional embodiments, the pressure sensor calibrator may be operated as a distributed logic across multiple network devices. In the embodiment depicted in FIG. 3, a plurality of APs 350 can operate as the pressure sensor calibrator in a distributed manner or may have one specific device operate as the pressure sensor calibrator for all of the neighboring or sibling APs 350. The APs 350 facilitate Wi-Fi connections for various electronic devices, such as but not limited to mobile computing devices including laptop computers 370, cellular phones 360, portable tablet computers 380 and wearable computing devices 390.

In further embodiments, the pressure sensor calibrator may be integrated within another network device. In the embodiment depicted in FIG. 3, a wireless LAN controller (WLC) 330 may have an integrated pressure sensor calibrator that the WLC 330 can use to calibrate the pressure sensors within the various APs 335 that the WLC 330 is connected to, either wired or wirelessly. In still more embodiments, a personal computer 325 may be utilized to access and/or manage various aspects of the pressure sensor calibrator, either remotely or within the network itself. In the embodiment depicted in FIG. 3, the personal computer 325 communicates over the communication network 320 and can access the pressure sensor calibrator of the servers 310, or the network APs 350, or the WLC 330.

Although a specific embodiment for various environments that the pressure sensor calibrator may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the pressure sensor calibrator may be provided as a device or software separate from the network devices or the pressure sensor calibrator may be integrated into the network devices. The elements depicted in FIG. 3 may also be interchangeable with other elements of FIGS. 1-2 and 4-8 as required to realize a particularly desired embodiment.

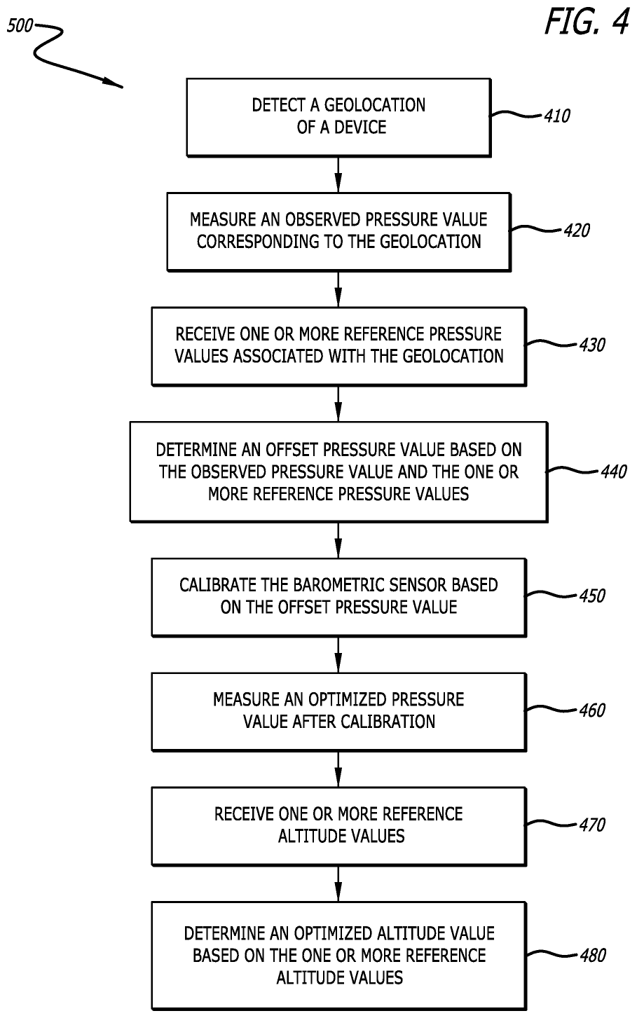

Referring to FIG. 4, a flowchart depicting a process 400 for calibrating the barometric sensor, in accordance with various embodiments of the disclosure is shown. In many embodiments, the process 400 can detect the geolocation of the device (block 410). In some embodiments, the device may be a network device in the network. In certain embodiments, the device can be an AP, a router, or a switch in the network, for example. In more embodiments, the process 400 may be performed by the device. In some more embodiments, the geolocation can lie within the sphere or the geoid of the predetermined diameter around the device. In numerous embodiments, the process 400 may obtain GNSS measurements or GPS measurements to determine the geolocation. In many further embodiments, the process 400 can average the GNSS measurements or the GPS measurements to determine latitude, longitude, or height corresponding to the geoid at the geolocation.

In a number of embodiments, the process 400 can measure the observed pressure value corresponding to the geolocation (block 420). In some embodiments, the observed pressure value may correspond to a real-time atmospheric pressure in vicinity of the device. In certain embodiments, the process 400 may utilize the barometric sensor in the device to measure the observed pressure value.

In various embodiments, the process 400 may receive one or more reference pressure values associated with the geolocation (block 430). In some embodiments, the process 400 may receive the one or more reference pressure values from the weather server. In certain embodiments, the process 400 can receive the one or more reference pressure values from the other devices in the network. In more embodiments, the process 400 may receive the one or more reference pressure values from the weather database. In some more embodiments, the process 400 can receive the one or more reference pressure values from the external devices. In numerous embodiments, the process 400 may receive the one or more reference pressure values from the barometric pressure server. In many further embodiments, the process 400 can receive the one or more reference pressure values from any other sources.

In additional embodiments, the process 400 can determine the offset pressure value based on the observed pressure value and the one or more reference pressure values (block 440). In some embodiments, the one or more reference pressure values may be a range of reference pressure values or may be a specific reference pressure value. In certain embodiments, the process 400 may compare the observed pressure value with the one or more reference pressure values. In more embodiments, the process 400 can determine a pressure difference between the observed pressure and the one or more reference pressure values or the range of the reference pressure values. In some more embodiments, the process 400 may determine the offset pressure value based on the pressure difference.

In further embodiments, the process 400 may calibrate the barometric sensor based on the offset pressure value (block 450). In some embodiments, the process 400 can introduce the offset pressure value as a bias that can be multiplied, added, or subtracted from an output of the barometric sensor to negate an effect of the drift of the barometric sensor. In certain embodiments, the process 400 may modify one or more coefficients of the barometric sensor to calibrate the barometric sensor. In more embodiments, the process 400 can modify or change one or more internal settings of the barometric sensor to calibrate the barometric sensor.

In many more embodiments, the process 400 can measure the optimized pressure value after calibration (block 460). In some embodiments, the optimized pressure value may be more accurate than the observed pressure value initially measured by the barometric sensor. In more embodiments, the process 400 may transmit the optimized pressure value to the other devices in the network. In some more embodiments, the process 400 can determine an altitude value based on the optimized pressure value. In numerous embodiments, the altitude value may be indicative of a height at which the device is deployed. In many further embodiments, the process 400 may transmit the altitude value to the other devices in the network.

In many additional embodiments, the process 400 may receive one or more reference altitude values (block 470). In some embodiments, the process 400 may receive the one or more reference altitude values from other devices in the network. In certain embodiments, the process 400 may receive the one or more reference altitude values from the weather database. In more embodiments, the process 400 can receive the one or more reference altitude values from the external devices. In many some more embodiments, the process 400 can receive the one or more reference altitude values from any other sources.

In many further embodiments, the process 400 can determine an optimized altitude value based on the one or more reference altitude values (block 480). In some embodiments, the altitude value determined by the process 400 may still have errors or deviations. In certain embodiments, the process 400 can improve the accuracy of the altitude value based on the received one or more reference altitude values. In more embodiments, the process 400 may determine the optimized altitude value based on the optimized pressure value and the one or more reference altitude values. In some more embodiments, the process 400 can transmit the optimized altitude value to the other devices in the network.

Although a specific embodiment for the process 400 for calibrating the barometric sensor for carrying out the various steps, processes, methods, and operations described herein is discussed with respect to FIG. 4, any of a variety of systems and/or processes may be utilized in accordance with embodiments of the disclosure. For example, the process 400 may dynamically or periodically calibrate or re-calibrate the barometric sensor to adapt to changing environmental or weather conditions. The elements depicted in FIG. 4 may also be interchangeable with other elements of FIGS. 1-3 and FIGS. 5-8 as required to realize a particularly desired embodiment.

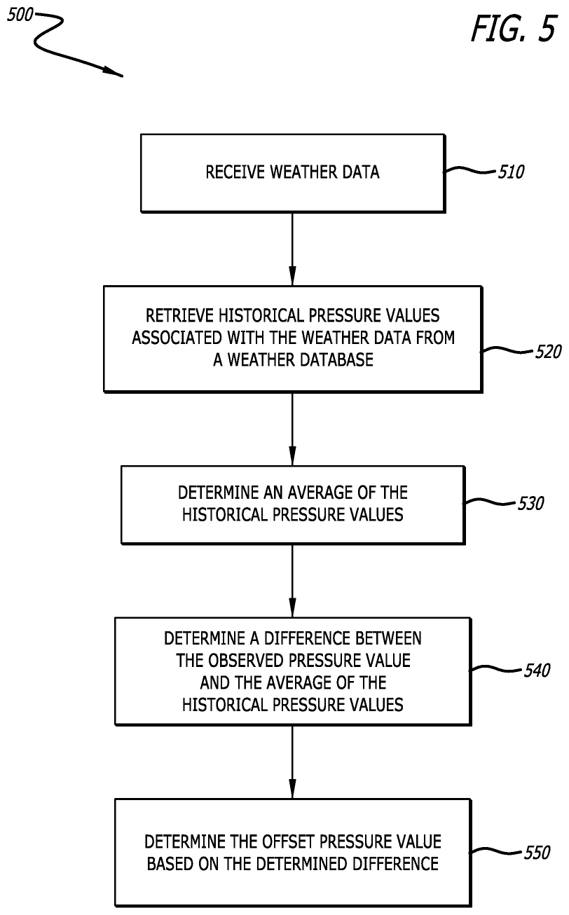

Referring to FIG. 5, a flowchart depicting a process 500 for determining the offset pressure value, in accordance with various embodiments of the disclosure is shown. In many embodiments, the process 500 can receive the weather data (block 510). In some embodiments, the process 500 may receive the weather data from the weather server. In certain embodiments, the weather data can be indicative of the real-time environmental conditions or weather conditions at the geolocation of the device.

In a number of embodiments, the process 500 may retrieve the historical pressure values associated with the weather data from a weather database (block 520). In some embodiments, the weather database may store the historical data associated with the weather conditions or the environmental conditions. In certain embodiments, the historical weather data can include the historical pressure values associated with various weather conditions and environmental conditions for various geolocations. In more embodiments, the process 500 may access the weather database by way of wired or wireless communication networks such as internet. In some more embodiments, the process 500 may access the online server capable of providing the historical data associated with the weather conditions or the environmental conditions. In numerous embodiments, the weather database may be within the network or external to the network. In many further embodiments, the process 500 can receive the historical pressure values associated with the weather data from the weather database. In still more embodiments, the historical pressure values can be associated with the environmental or weather condition similar to the real-time environmental or weather condition indicated by the weather data. In many additional embodiments, the historical pressure values may be associated with different environmental or weather conditions, or may be the average of pressure values in similar environmental or weather conditions.

In various embodiments, the process 500 may determine the average of the historical pressure values (block 530). In some embodiments, the average of the historical pressure values may be determined for same or similar environmental or weather conditions over a predetermined period of time. In certain embodiments, for example, the average of the historical pressure values may be indicative of the average atmospheric pressure in a given season for a predetermined number of years. In some more embodiments, the process 500 can determine a plurality of difference values. In numerous embodiments, each difference value may be a difference between the observed pressure value and the historical pressure values. In many embodiments, the historical pressure values and the observed pressure value may be measured at same time or at a substantially similar time.

In additional embodiments, the process 500 can determine the difference between the observed pressure value and the average of the historical pressure values (block 540). In some embodiments, the observed pressure value may differ from the average of the historical pressure values because of the drift of the barometric sensor. In certain embodiments, the difference between the observed pressure value and the average of the historical pressure values may change based on different weather conditions, seasons, environmental variations, or temperature variations. In some more embodiments, the process 500 may determine an average of the difference values.

In further embodiments, the process 500 may determine the offset pressure value (block 550). In some embodiments, the process 500 can utilize the offset value to calibrate or recalibrate the barometric sensor. In certain embodiments, the process 500 can introduce the offset pressure value as the bias for the barometric sensor to compensate for the effect of the drift of the barometric sensor. In many embodiments, the process 500 can determine the offset pressure value based on the difference. In some more embodiments, the process 500 may determine the offset pressure value based on the average of the difference values.

Although a specific embodiment for the process 500 for determining the offset pressure value for carrying out the various steps, processes, methods, and operations described herein is discussed with respect to FIG. 5, any of a variety of systems and/or processes may be utilized in accordance with embodiments of the disclosure. For example, the process 500 may calibrate the barometric sensor based on a dynamically calculated offset value. The elements depicted in FIG. 5 may also be interchangeable with other elements of FIGS. 1-4 and FIGS. 6-8 as required to realize a particularly desired embodiment.

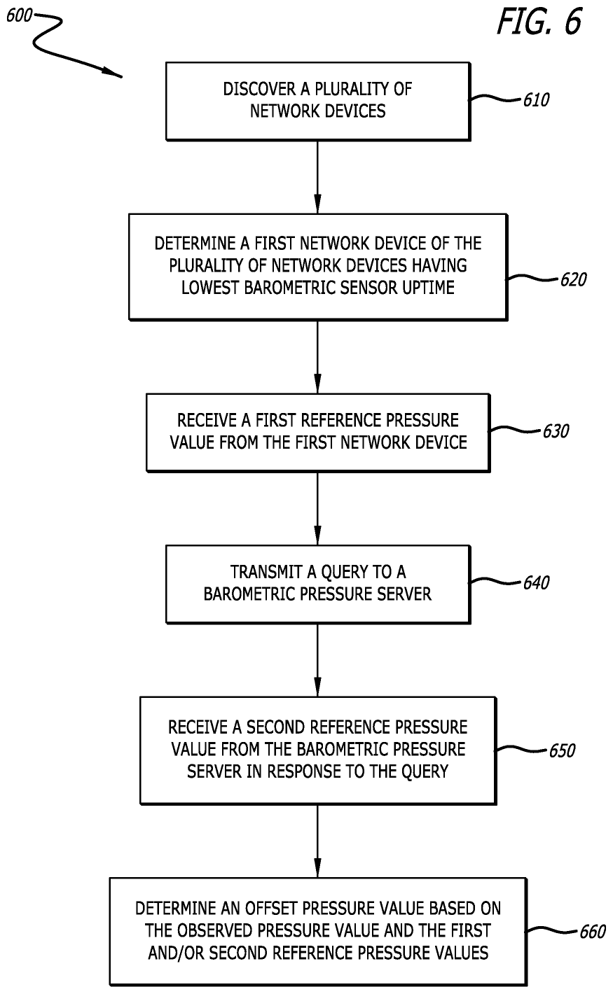

Referring to FIG. 6, a flowchart depicting a process 600 for determining the offset pressure value, in accordance with various embodiments of the disclosure is shown. In many embodiments, the process 600 can discover a plurality of network devices (block 610). In some embodiments, the network may have multiple interconnected network devices deployed at various distances. In certain embodiments, each network device can discover other network devices in the network by utilizing one or more communication protocols. In more embodiments, the network devices may also discover other network devices at boot-up or when a new network device is added to the network. In some more embodiments, the examples of the network devices may include, APs, switches, or routers, for example. In numerous embodiments, the process 600 may be implemented by one or more network devices. In still many embodiments, the process 600 can receive reference pressure values from many sources.

In a number of embodiments, the process 600 may determine a first network device of the plurality of network devices having lowest barometric sensor uptime (block 620). In some embodiments, the process 600 can determine uptimes of the other network devices or the uptimes of the barometric sensors in the other network devices. In more embodiments, for example, the first network device may be newly added to the network, and hence, may have the lowest uptime. In some more embodiments, the since the network devices may be typically calibrated while adding to the network, the first network device may have most accurate measurements for pressure or altitude.

In various embodiments, the process 600 can receive a first reference pressure value from the first network device (block 630). In some embodiments, the process 600 may also receive a first reference altitude value from the first network device. In certain embodiments, the process 600 may utilize the first reference pressure value and the first reference altitude value received from the first network device to calibrate or re-calibrate the barometric sensor. In more embodiments, the process 600 may transmit the first reference pressure value to the other network devices in the network.

In additional embodiments, the process 600 may transmit a query to the barometric pressure server (block 640). In some embodiments, for example, the barometric pressure server may store the historical pressure values for various environmental conditions or weather conditions. In certain embodiments, the barometric pressure server may include the barometric database. In more embodiments, the barometric pressure server can be located in the network or may be external to the network. In some more embodiments, the barometric pressure server may be provided as SaaS. In numerous embodiments, the query can include the geolocation of the network device. In many further embodiments, the process 600 may select the barometric pressure server from a plurality of barometric pressure servers that are in proximity to the network device. In still more embodiments, the process 600 can select the barometric pressure server that is closest to the network device.

In further embodiments, the process 600 can receive a second reference pressure value from the barometric pressure server in response to the query (block 650). In some embodiments, the process 600 may transmit the second reference pressure value to the other network devices in the network. In certain embodiments, the process 600 can further utilize the second reference pressure value received from the barometric pressure server to calibrate or re-calibrate the barometric sensor.

In many more embodiments, the process 600 may determine the offset pressure value based on the observed pressure value and the first and/or second reference pressure values (block 660). In some embodiments, the process 600 can determine the pressure difference between the observed pressure value and the first and/or second reference pressure values. In certain embodiments, the process 600 may determine the offset pressure value based on the pressure difference.

Although a specific embodiment for the process 600 for determining the offset pressure value for carrying out the various steps, processes, methods, and operations described herein is discussed with respect to FIG. 6, any of a variety of systems and/or processes may be utilized in accordance with embodiments of the disclosure. For example, the process 600 may utilize a plurality of reference pressure values simultaneously to calibrate the barometric sensor. The elements depicted in FIG. 6 may also be interchangeable with other elements of FIGS. 1-5 and FIGS. 7-8 as required to realize a particularly desired embodiment.

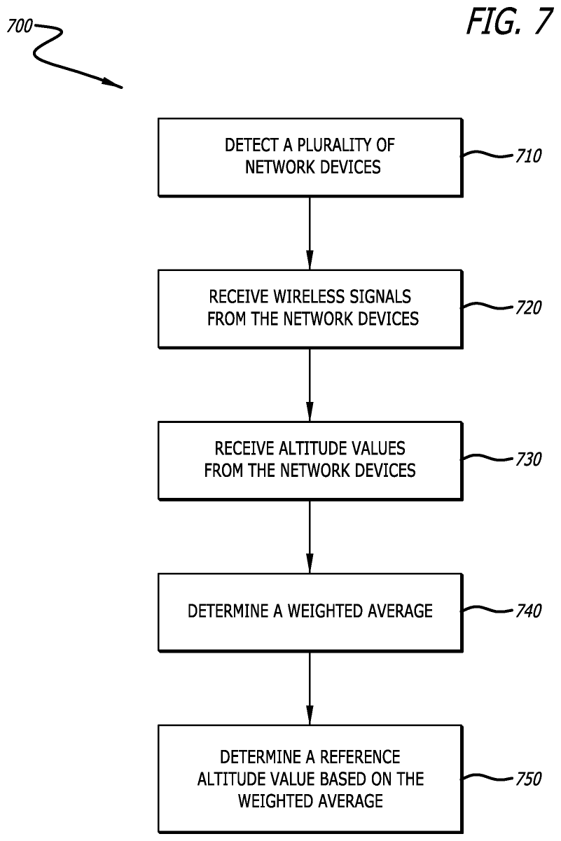

Referring to FIG. 7, a flowchart depicting a process 700 for determining the reference altitude value, in accordance with various embodiments of the disclosure is shown. In many embodiments, the process 700 can detect the plurality of network devices (block 710). In some embodiments, the network may have multiple interconnected network devices deployed at various distances. In certain embodiments, each network device can discover the other network devices in the network by utilizing the one or more communication protocols. In more embodiments, the network devices may also discover the other network devices at boot-up or when a new network device is added to the network. In some more embodiments, the examples of the network devices may include, APs, switches, or routers, for example. In numerous embodiments, the process 700 may be implemented by the one or more network devices.

In various embodiments, the process 700 may receive wireless signals from the network devices (block 720). In some embodiments, the wireless signals may be Wi-Fi signals. In certain embodiments, the process 700 may determine strengths of the Wi-Fi signals received from the network devices. In certain embodiments, for example, the process 700 can determine RSSI values for the wireless signals. In more embodiments, for example, the wireless signals from the network devices that are at larger distances may have poor RSSI values (for e.g., −80 dBm) than the network devices that are at smaller distances (for e.g., −60 dBm).

In additional embodiments, the process 700 can receive altitude values from the network devices (block 730). In some embodiments, the process 700 may utilize a Neighbor Discovery Protocol (NDP) or any other Internet Protocol (IP) to share the altitude values between the network devices. In certain embodiments, the process 700 can modify NDP to share the pressure and/or altitude measurements in the network.

In further embodiments, the process 700 may determine the weighted average (block 740). In some embodiments, the process 700 can determine the weighted average based on the RSSI values and corresponding altitudes. In certain embodiments, for example, the altitude value obtained from the network device with poor RSSI can be given a lower weightage and the altitude value obtained from the network device with better RSSI can be given a higher weightage.

In many more embodiments, the process 700 can determine the reference altitude value based on the weighted average (block 750). In some embodiments, the process 700 may transmit the reference altitude value to the other network devices. In certain embodiments, the process 700 can utilize the reference altitude value obtained by the weighted average to calibrate or re-calibrate the barometric sensor.

Although a specific embodiment for the process 700 for determining the reference altitude value for carrying out the various steps, processes, methods, and operations described herein is discussed with respect to FIG. 7, any of a variety of systems and/or processes may be utilized in accordance with embodiments of the disclosure. For example, the process 700 may optimize the altitude measurement of the network device based on the reference altitude value. The elements depicted in FIG. 7 may also be interchangeable with other elements of FIGS. 1-6 and FIG. 8 as required to realize a particularly desired embodiment.

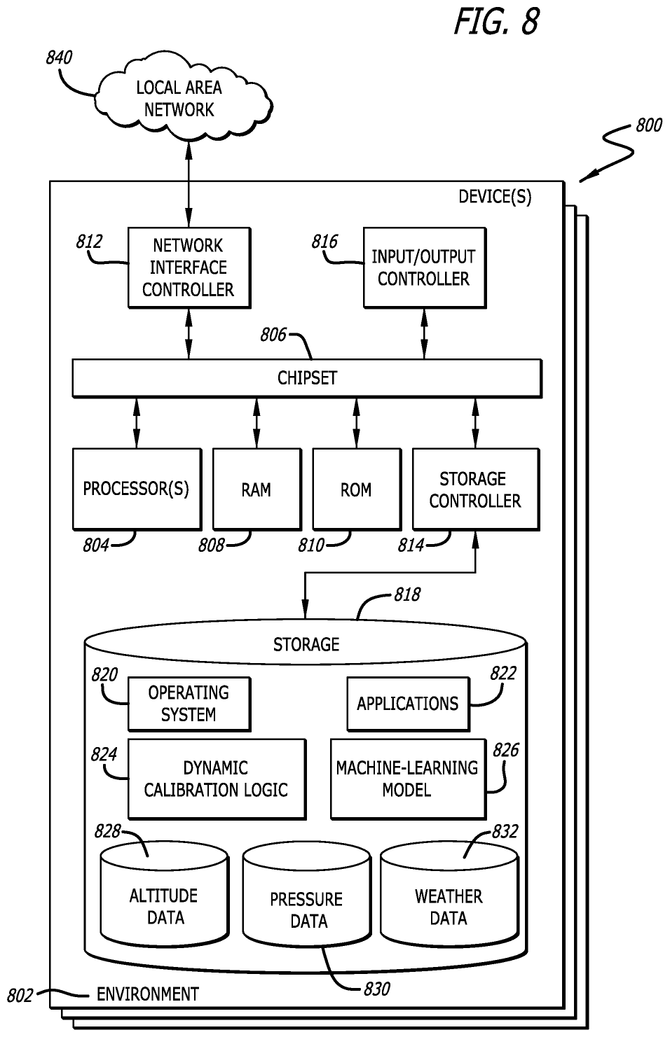

Referring to FIG. 8, a conceptual block diagram of a device 800 suitable for configuration with a dynamic calibration logic, in accordance with various embodiments of the disclosure is shown. The embodiment of the conceptual block diagram depicted in FIG. 8 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 8 can also illustrate an access point, a switch, or a router in accordance with various embodiments of the disclosure. The device 800 may, in many non-limiting examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, central processing units (“CPUs”) can be configured to operate in conjunction with a chipset 806. The processor(s) 804 can be standard programmable CPUs that perform arithmetic and logical operations necessary for the operation of the device 800.

In a number of embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 806 may provide an interface between the processor(s) 804 and the remainder of the components and devices within the environment 802. The chipset 806 can provide an interface to a random-access memory (“RAM”) 808, which can be used as the main memory in the device 800 in some embodiments. The chipset 806 can further be configured to provide an interface to a computer-readable storage medium such as a read-only memory (“ROM”) 810 or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Additional embodiments of the device 800 can be configured to operate in a networked environment using logical connections to remote computing devices and computer systems through a network, such as the network 840. The chipset 806 can include functionality for providing network connectivity through a network interface card (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for instance, store an operating system 820, applications 822, altitude data 828, pressure data 830, and weather data 832 which are described in greater detail below. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The altitude data 828 can store the altitude values and/or the optimized altitude value determined by the device 800. The altitude data 828 can also store the reference altitude values received by the device 800. The pressure data 830 can store the observed pressure values measured by the device 800 and/or the reference pressure values received by the device 800. The weather data 832 may store historical weather data and/or real-time weather data.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

In many more embodiments, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 818 can store other system or application programs and data utilized by the device 800.

In many additional embodiments, the storage 818 or other computer-readable storage media is encoded with computer-executable instructions which, when loaded into the device 800, may transform it from a general-purpose computing system into a special-purpose computer capable of implementing the embodiments described herein. These computer-executable instructions may be stored as application 822 and transform the device 800 by specifying how the processor(s) 804 can transition between states, as described above. In some embodiments, the device 800 has access to computer-readable storage media storing computer-executable instructions which, when executed by the device 800, perform the various processes described above with regard to FIGS. 1-7. In certain embodiments, the device 800 can also include computer-readable storage media having instructions stored thereupon for performing any of the other computer-implemented operations described herein.

In many further embodiments, the device 800 may include a dynamic calibration logic 824. The dynamic calibration logic 824 can be configured to perform one or more of the various steps, processes, operations, and/or other methods that are described above. Often, the dynamic calibration logic 824 can be a set of instructions stored within a non-volatile memory that, when executed by the processor(s)/controller(s) 804 can carry out these steps, etc. In some embodiments, the dynamic calibration logic 824 may be a client application that resides on a network-connected device, such as, but not limited to, a server, switch, personal or mobile computing device in a single or distributed arrangement. The dynamic calibration logic 824 can calibrate or re-calibrate the pressure sensor in the device 800.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8 and can include other components that are not explicitly shown in FIG. 8 or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein.

Finally, in numerous additional embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826.

The ML model(s) 826 can be configured to generate inferences to make predictions or draw conclusions from data. An inference can be considered the output of a process of applying a model to new data. This can occur by learning from at least the altitude data 828, the pressure data 830, and the weather data 832 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 826 may be generated by human/administrator verifications or may compare predicted outcomes with actual outcomes.

Although a specific embodiment for the device 800 suitable for configuration with the dynamic calibration logic for carrying out the various steps, processes, methods, and operations described herein is discussed with respect to FIG. 8, any of a variety of systems and/or processes may be utilized in accordance with embodiments of the disclosure. For example, the device 800 may be in a virtual environment such as a cloud-based network administration suite, or it may be distributed across a variety of network devices or switches. The elements depicted in FIG. 8 may also be interchangeable with other elements of FIGS. 1-7 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
a dynamic calibration logic, configured to:
detect a geolocation of the device;
measure an observed pressure value corresponding to the geolocation;
receive one or more reference pressure values associated with the geolocation; and
determine an offset pressure value based on the observed pressure value and the one or more reference pressure values.

2. The device of claim 1, wherein the dynamic calibration logic is further configured to:
receive weather data;
retrieve a plurality of historical pressure values associated with the weather data from a weather database; and
determine the offset pressure value based on the plurality of historical pressure values.

3. The device of claim 1, wherein the dynamic calibration logic is further configured to determine:
a plurality of difference values, wherein each difference value of the plurality of difference values corresponds to a difference between the observed pressure value and a historical pressure value of the plurality of historical pressure values;
an average of the plurality of difference values; and
the offset pressure value based on the average of the plurality of difference values.

4. The device of claim 1, further comprising a barometric sensor configured to measure the observed pressure value.

5. The device of claim 4, wherein the dynamic calibration logic is further configured to calibrate the barometric sensor based on the offset pressure value.

6. The device of claim 5, wherein the barometric sensor is further configured to measure an optimized pressure value after calibration.

7. The device of claim 6, wherein the dynamic calibration logic is further configured to discover a plurality of network devices.

8. The device of claim 7, wherein the dynamic calibration logic is further configured to:
determine a first network device of the plurality of network devices having lowest barometric sensor uptime; and
receive a first reference pressure value of the one or more reference pressure values from the first network device.

9. The device of claim 8, wherein the dynamic calibration logic is further configured to:
transmit a query to a barometric pressure server; and
receive a second reference pressure value of the one or more reference pressure values from the barometric pressure server in response to the query.

10. The device of claim 9, wherein the dynamic calibration logic is further configured to determine an optimized altitude based on one or more reference altitude values.

11. The device of claim 10, wherein the dynamic calibration logic is further configured to calibrate the barometric sensor based on the optimized altitude.

12. The device of claim 10, wherein the dynamic calibration logic is further configured to transmit the optimized altitude to one or more network devices of the plurality of network devices.

13. The device of claim 12, wherein the dynamic calibration logic is further configured to receive a first reference altitude value of the one or more reference altitude values or a third reference pressure value of the one or more reference pressure values from an external device.

14. The device of claim 13, wherein the dynamic calibration logic is further configured to:
receive a plurality of wireless signals from the plurality of network devices;
receive a plurality of altitude values from the plurality of network devices;
determine a plurality of Received Signal Strength Indicator (RSSI) values for the plurality of wireless signals;
determine a weighted average based on the plurality of altitude values and corresponding plurality of RSSI values; and
determine a second reference altitude value of the one or more reference altitude values based on the weighted average.

15. A device, comprising:
a processor;
a memory communicatively coupled to the processor;
a Global Navigation Satellite System (GNSS) receiver configured to detect a geolocation of the device;
a barometric sensor configured to measure an observed pressure value corresponding to the geolocation; and
a dynamic calibration logic, configured to:
receive one or more reference pressure values associated with the geolocation;
determine an offset pressure value based on the observed pressure value and the one or more reference pressure values; and
calibrate the barometric sensor based on the offset pressure value.

16. The device of claim 15, wherein the dynamic calibration logic is further configured to determine an optimized altitude based on one or more reference altitude values.

17. The device of claim 16, wherein the dynamic calibration logic is further configured to calibrate the barometric sensor based on the optimized altitude.

18. The device of claim 17, wherein the dynamic calibration logic is further configured to transmit the optimized altitude to one or more network devices.

19. A method comprising:
detecting a geolocation by utilizing a Global Navigation Satellite System (GNSS) receiver;
measuring an observed pressure value corresponding to the geolocation by utilizing a barometric sensor;
receiving one or more reference pressure values associated with the geolocation;
determining an offset pressure value based on the observed pressure value and the one or more reference pressure values; and
calibrating the barometric sensor based on the offset pressure value.

20. The method of claim 19, further comprising:
determining an optimized altitude based on one or more reference altitude values; and
calibrating the barometric sensor based on the optimized altitude.
